(19) United States
(12) Patent Application Publication
(10) Pub. No.: US 2006/0155802 A1
(43) Pub. Date: Jul. 13, 2006

(54) Method to realize dynamic networking and resource sharing among equipments

(76) Inventors: Zhiqiang He, Beijing (CN); Jingnan Huang, Beijing (CN); Xiangdong Liu, Beijing (CN); Yujin Luo, Beijing (CN); Dekui Zhang, Beijing (CN); Yuanyi Zhang, Beijing (CN); Yanpin Ren, Beijing (CN); Ming Li, Beijing (CN); Chuang Meng, Beijing (CN); Shan Jiang, Beijing (CN)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 10/514,341

(22) PCT Filed: May 16, 2003
(86) PCT No.: PCT/CN03/00361

§ 371 Date: Jul. 14, 2005

(30) Foreign Application Priority Data
May 17, 2002 (CN) 02117334.6
Sep. 6, 2002 (CN) 02129653.7
Sep. 10, 2002 (CN) 02130630.3

(51) Int. Cl. G06F 15/16

(52) U.S. Cl. 709/203

(57) ABSTRACT

The invention relates to a method allowing dynamically networking among a plurality of devices to share resource. It includes: installing a software of dynamic networking and resource sharing on each of devices to realize dynamic networking and resource sharing. These devices periodically announce information with multicasting. A device serves as node control device, and announces the message of the existence of the device through multicasting, creates a node. A device can find the node by monitoring announcement message from the node. The device which requests to join into the node device registers its service information that can be provided by the device to the node control device. The device which has joined into the node finds the device providing service by indexing the nodal control device, and obtains desired service from the device by sending a service calling information. The method is applied to home backbone network for performing networking in home network. Then a topology connection structure with master/slave and peer-to-peer modes can be realized. The dynamic networking and resource sharing between the service providing device and the service utilizing device in the home backbone network can be realized.

### BACKGROUND OF THE INVENTION

1. Field of Invention

This invention relates to computer networks and distributed computation, and more particularly, to a method of supporting the interconnection among devices in a network environment, which includes a method for dynamically networking so as to share resource.

2. Description of Prior Art

Conventional network technologies have provided a basic communicating and addressing method for network devices, such as a family of Transmission Control Protocol/Internet Protocol (TCP/IP). However, there still exists a need for an architecture and a method that can realize dynamically networking and sharing resource among the devices.

The dynamically networking among devices involved in the present invention means that: a) there is no need to modify network parameters of a device in a network; b) a node can be constructed by dynamically choosing the relative devices from the network, and the node can realize a function which can not be achieved by a single device, or improve the performance of original function of the single device; and c) two nodes can directly communicate and share resource therebetween so as to extend a function of a single node.

The resource sharing involved in the present invention refers to that in a case where the number of the network devices is not increased, the devices in the network can readily issue the resources provided by themselves, and also can retrieve and use the resources provided by other devices readily.

A lot of standards and methods have already been proposed by some organizations and companies all over the world, and they can, in different degrees, realize the dynamic networking and resource sharing among the network devices.

UPNP Forum has already proposed a network architecture in view of controlling home appliances: Those network devices based on UPNP can dynamically form a peer-to-peer network, in which each device can dynamically issue its resource and retrieve the resource of other devices in the network. But what UPNP provided is a method for a device as a control point controlling another device, but not a method to realize dynamically networking and resource sharing among a plurality of devices.

CORBA is a distributed computing technique across platforms proposed by International Object Management Group. This technique requires that there is a central server dedicated for realizing object retrieve in the network. Such an application model is more suitable for a Client/Server mode but can not support the dynamic networking, resource sharing and cooperation among a plurality of devices very well.

Microsoft® Corporation has proposed a DCOM distributed computing technique. But the implementation of such a technique is only limited to the system platform of Microsoft, and only a new Client/Server computing platform is provided.

Currently, various new appeared peer-to-peer techniques focus on how to realize resource sharing without depending on a central server in Internet environment. Typical technical solutions include Freenet, Gnutella and Napster. However, the extensions of sharing resources realized by those typical solutions are much smaller, and are most of them are limited to share static files.

Grid has proposed a technique for realizing resource sharing in a network environment across organizations or companies. However, hitherto, this technique is still only a developing frame and can not provide an embodied method for dynamically networking and resource sharing.

Thus, although various existing distributed computing techniques have already proposed a plurality of technical solutions for specific resource issuing and retrieves with respect to single device, the problem involved in dynamically networking and resource sharing and cooperation among a plurality of devices is still remaining unsolved.

### SUMMARY OF THE INVENTION

Therefore, an object of the present invention is to provide a method for realizing dynamically networking and resource sharing which can realize dynamically networking and resource sharing among a plurality of devices in a network. According to the method of the present invention, the devices in the network are capable of connecting with each other freely and dynamically without changing original network parameters. Further, each of devices in the network can not only issue its resource, but also retrieve and use the resource of other devices.

Another object of the present invention is to provide a networking method for backbone network of home network, which can realize dynamically networking and resource sharing among home network devices by establishing a basic constitute frame of the home backbone network.

Still another object of the present invention is to provide a method for realizing dynamically networking and resource sharing in a home backbone network, which makes respective independent devices containing processors and memory units in home network environment dynamically connect together so as to form a network in which the respective devices can access to each other and use the resource on other devices. New devices can be joined into the network at any moment so as to improve the interoperability and easy usage between the home devices.

To achieve the above objects of the present invention, there is provided a method for realizing dynamically networking and resource sharing among devices, comprising the steps of:

A1. installing a dynamically networking and resource sharing module set on each of devices which need to realize dynamically networking and resource sharing, said module set including a network transmission layer module for transmission and reception of data; a device management layer module for establishing connection relation among the devices to control and manage the device; a service management layer module for performing a service management for the devices and nodes. These devices periodically send device messages to the network by means of multicasting;

B1. a device serving as a node control device and announcing message of its existence by means of multicasting so as to create a node;

C1. a device finding the node by monitoring the node announcement message, and the devices which request to register in the node registering service information, which it can provide, to the node control device of the node; or the node control device configuring other devices on the network so as to make said devices have to register service information which they can provide to the node control device and thus register in the node;

D1. the device which has registered in the node finding a device providing desired service by indexing the node control device, and obtaining a desired service from said device by sending a service request message to the device which provides the desired service.

Said nodes comprise global nodes and specific nodes. Service entities on all devices belong to the same global node in default. A service entity on any one of the devices can create a specific node other than the global nodes.

According to the present invention, a plurality of services (devices) are dynamically combined by creating global nodes and specific nodes, thereby sharing resource. One global node may have one service entity (device) which is able to perform node management, and if such an entity exists, all the other services (devices) register to said service (device) and are managed by said entity (device). All the service entities (device) belonging to the same global node in default can create a specific node other than the global nodes and can invite or configure other service entities (devices) to register in the newly created specific node. After the creation of a new global node or a specific node, its node management service entity announces the message of its existence to the network, and other service entities, as soon as receiving the announced message from the global or specific nodes, can send a register request to the management service entity (device) of the global or specific nodes. Thus, the object of the present invention that each of devices in the network can not only announce its own resources but also retrieve and use the resources of other devices is achieved.

According to the present invention, the method to implement dynamically networking and resource sharing among devices further comprises a communicating method among nodes, including steps:

E1. a source node control device and a destination node control device send respective node announcement messages of their own nodes to the network respectively;

F1. the source node control device and the destination node control device, by using the procedures of initiating request and receiving request, establish a relationship of resource sharing between the two nodes and exchange resource information respectively;

G1. a device within the source node sends a request, which is transferred by the destination node control device, to its node control device to call for the resource of a device within the destination node;

H1. the device within the destination node sends back a resource calling response, which is transferred by the source node control device, to the device within the source node.

According to the present invention, the node resource information can be exchanged with each other by establishing a resource sharing relation through communication mechanism between two nodes (which may be between global nodes, between specific nodes, and between a global node and a specific node). Thus, the devices within the two nodes can perform resource sharing through respective node control device.

To achieve the above objects of the present invention, there is also provided a networking method for a home backbone network, comprising the steps of:

A2. providing at least one service providing device for providing services to other devices in the home network;

B2. providing at least one service utilizing device for utilizing the services provided by other devices in the home network;

C2. providing at least one protocol gateway for connecting the home backbone network with an external network;

D2. connecting the service providing device, the service utilizing device and the protocol gateway by using a broadband and high rate home backbone network protocol to form the home backbone network.

The service providing device and the service utilizing device in Steps A2 and B2 may be a same physical device.

Said home backbone network adopts a wired transmission mode or a wireless transmission mode or both of them.

Said one service providing device or said one service utilizing device or protocol gateway is designated as a resource management device of the home backbone network so as to constitute a backbone network topological structure of Master/Slave connection mode between the resource management device and other devices, and the resource management device performs centralized control to other devices.

Said centralized control includes that the service providing device and/or the service utilizing device, after successfully registering to the resource management device, join into the home backbone network, as well as the service utilizing device which has joined into the home backbone network indexes services from the resource management device.

Said service providing device, service utilizing device and protocol gateway form a peer-to-peer connecting backbone network topological structure by using a peer-to-peer connecting mode.

Said peer-to-peer connection is performed in such a manner that a source device requesting connection sends a peer-to-peer connection creation request to a destination device and the destination device send a peer-to-peer connection creation response to the source device.

Said destination device and source device can be the service providing device or the service utilizing device for each other.

Said service providing device and service utilizing device are interchangeable, and a home backbone network can be both a service providing device and a service utilizing device.

The method for establishing the home backbone network according to the present invention, on the basis of the description of the home backbone network and the members thereof, can realize dynamically networking and resource sharing by using the provided home backbone network model, i.e., Master/Slave connecting mode and peer-to-peer connecting mode.

To achieve the above objects of the present invention, there is also provided a method for realizing dynamically networking and resource sharing among devices in a home backbone network, comprising the steps of:

A3. connecting a home backbone network device to a local area network or a wireless local area network;

B3. multicasting information of said device by issuing an announcement message of said device;

C3. obtaining an message of existence of other devices by monitoring or looking up the announcement message;

D4. a service utilizing device and a service providing device, together with one resource management device, constituting one home network by registering to said resource management device; or more than one service utilizing devices and service providing devices constituting one home network by using peer-to-peer connecting mode;

E3. the service utilizing device obtains service information of the service providing device within the home network by sending a service looking up request to the resource management device, and the service utilizing device obtains a right to use a service, and uses the service provided by the service providing device by sending a service renting request or a service calling request; or the service utilizing device obtains service information of a service providing device and a right to use a service, and uses the service provided by the service providing device by sending a service looking up request, a service renting request and a service calling request to the service providing device which has established a peer-to-peer connection with the service utilizing device.

In said step A3, said home backbone network may include information devices, communication devices and entertainment devices. Information of the device and services thereof is encapsulated and issued in accordance with a description specification of a device and its services of a backbone network protocol.

For said backbone network protocol, a backbone network protocol stack includes a transmission management layer for data interaction among devices and services, an intermediate protocol layer for realizing an interconnection and resource sharing among the devices in the home network, and application support layer for providing an API access interface for an upper layer application program.

In said step B3, the device periodically announces its own information with multicasting. The issued announcement message at least includes a device description, a network addressing identification of the device and service information carried by the device.

In said step C3, said monitoring includes that the device obtains the messages of existence of other devices by monitoring the announcement messages of other devices; and said looking up includes that the device sends a message to look up other devices with multicasting, and a device which receives the looking up message multicast returns its own device announcement message with unicasting when the conditions of the device itself is consistent with the looking up conditions contained in the looking up message.

In said step D3, when the resource management device is designated in the service utilizing or service providing device, the service utilizing device or service providing device initiates a registering procedure to the resource management device existing in the network.

In said step D3, said service utilizing device or service providing device only registers to one resource management device at the same time.

Said step D3 further comprises steps of the service providing device which has successfully registered to the resource management device registers its own service to the resource management device, and the resource management device maintains all devices and their service information registered thereto.

In said step D3, i.e. the step of more than one devices constitute one home backbone network by using peer-to-peer connecting mode further comprises the steps of a device obtains the messages of existence of other devices by monitoring multicast announcement messages of other devices, and a device initiates a peer-to-peer connection establishing request to other devices so as to request services on other devices.

Said step D3 further comprises a establishing procedure of a security mechanism, including the steps of:

D31. the resource management device sends authentication information to the devices joined into the home network, wherein a key configuration management program is responsible to a authentication key thereof and if the authentication is passed, then the registration is successful;

D32. performing a connection authentication between two peer-to-peer connected devices, a connection authentication key being issued by the key configuration management program and being maintained locally by the two peer-to-peer connected devices.

The method according to the present invention allow home appliances dynamically networking as a whole, and allow various devices to provide a systematical and complete service for a home user jointly. The characteristic of openness possessed has fully considered future development and support to existing techniques and devices.

The method according to the present invention supports both a wired network and a wireless network.

### BRIEF DESCRIPTION OF THE DRAWINGS

FIG. 1 is a schematic diagram showing a logic structure for devices which abstracts all physical network devices in the present invention into respective logic devices in view of functionalities;

FIG. 2 is a schematic diagram showing the constitution of a global node according to an embodiment of the present invention;

FIG. 3 is a diagram showing a procedure for generating a (global or specific) node according to the embodiment of the present invention;

FIG. 4 is a diagram showing a procedure for communicating among nodes according to the embodiment of the present invention;

FIG. 5 is a diagram showing when the node generation mechanism according to the embodiment of the present invention is applied to a meeting room;

FIG. 6 is a diagram showing one example of a home network established according to the method of the present invention;

FIG. 7 is a diagram showing a topological structure of a home backbone network connected in a Master/Slave connecting mode and resource sharing;

FIG. 8 is a diagram showing a topological structure of a home backbone network connected in a peer-to-peer connecting mode and resource sharing;

FIG. 9 is a diagram showing a hierarchical structure of a device protocol stack used by the home backbone network;

FIG. 10 is a diagram showing a transmission management layer shown in FIG. 9;

FIG. 11 is a diagram showing an intermediate protocol layer shown in FIG. 9; and

FIG. 12 is a flow chart showing the process of dynamic networking and resource sharing among devices in the home backbone network according to the present invention.

### DETAILED DESCRIPTION OF THE PREFERRED EMBODIMENTS

The present invention will be described referring to the accompanying drawings.

The method according to the present invention need not increase any new device on the basis of original devices existing in a network, but only need to install additional software onto the devices desired to have functions of dynamic networking and resource sharing. The dynamic networking and resource sharing in a limited extension according to the present invention is accomplished by that software. One device can intelligently establish an underlayer communication link with other devices, announce information relative to it own to other devices, find other devices which possess such software in that network, and dynamically and intelligently form one node (a combination of a plurality of services) together with them in demand so as to support a sharing and integration of services distributed on the plurality of devices. Those services are provided by a resource entity which has a certain function, and includes cooperation among software or hardware or both of them. For example, in a printer, a physical device of the printer provides a printing service through a printing driving program.

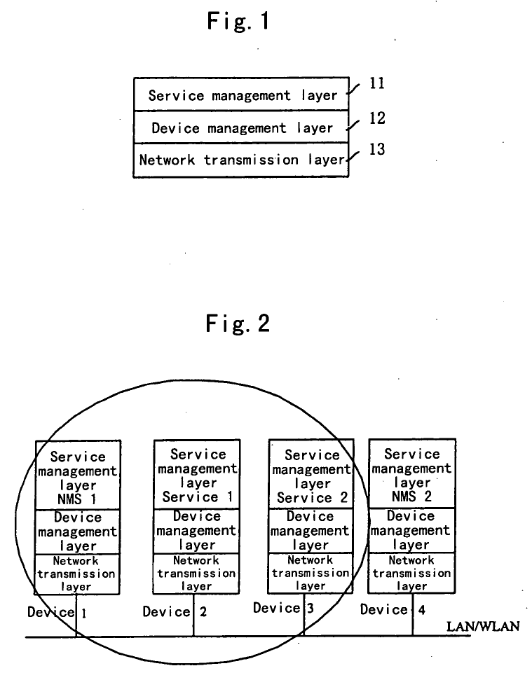

Referring to FIG. 1 which is a schematic diagram of a logic structure for devices which abstracts all physical network devices in the present invention into respective logic devices in view of functionalities, a service management layer 11, a device management layer 12 and a network transmission layer 13 are contained. The network transmission layer 13 is used to transmit and receive data. The device management layer 12 performs a control and management to a connection among the devices, such as identification authentication among the devices. The service management layer 11 performs a service management to the devices themselves, such as security checks to a service invocation.

It is necessary to form a node consisting of a plurality of devices in the network to implement the method according to the present invention. It also need a device to implement a node management function. The device, which implements the node management function, is a node control device. That is, one node consists of one node control device and possible a plurality of devices. A service entity, which can perform the node management function, must exist on the node control device. And a service entity, which can perform the node management function, may also exist on each device for implementing the method according to the present invention. Inside of one node, however, a service management service entity on only one device is active at the same time.

The node control device may be designated by users or dynamically generated.

The nodes in the present invention may include two types of nodes, one is global nodes and the other is a specific nodes. All service entities in the same broadcasting domain belong to a same global node in default. Any one of the service entities can create a specific node other than the global node.

Referring to FIG. 2, this figure show a schematic diagram of constituting a node for implementing the method according to the present invention. As shown in FIG. 2, a device 1, a device 2, a device 3 and a device 4 are connected to a Local Area Network (LAN) or a Wireless Local Area Network (WLAN). The devices 1, 2 and 3 encompassed in the elliptic line constitute a node 1. A service entity NMS1 (Node Manager Service) managing the node 1 is provided in the device 1 and forms a control device for the node 1. The device 2 and the device 3 are server (Service) 1 and server (Service) 2, respectively. A service entity NMS 2 managing a node 2 is provided in the device 4 and forms a control device for the node 2.

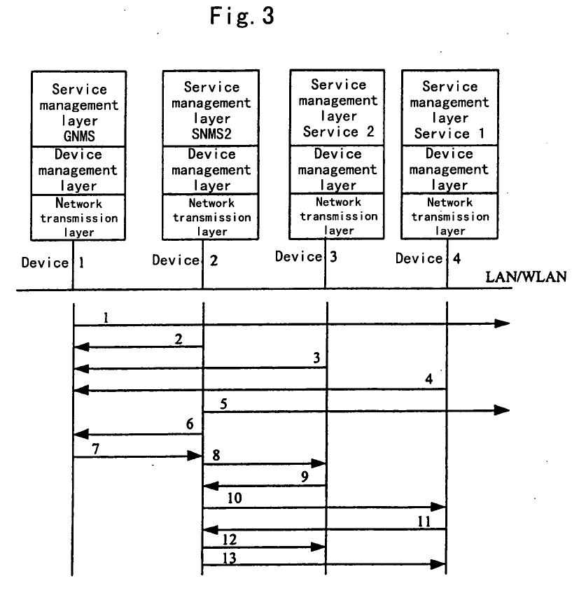

Referring to FIG. 3, a device 1, a device 2, a device 3 and a device 4 are connected to LAN/WLAN, wherein a global node management service (GNMS) is a service entity on the device 1 to perform a global node management, a specific node management service (SNMS) is a service entity on the device 2 to perform a specific node management. Service 1 is a service on the device 3, and Service 2 is a service on the device 4.

The meanings of the steps in FIG. 3 are as follows:

Step 1, the device 1 creates a global node and announces its global node message to network LAN/WLAN;

Step 2, Step 3 and Step 4, the device 2, the device 3 and the device 4 respectively join into the global node;

Step 5, the device 2 creates a new specific node, and announces a relative specific node message to the network;

Step 6, the device 2 enquiries service information existing in the network from the global node;

Step 7, the device 1 returns the corresponding service information to the device 2;

Step 8, the device 2 invites the device 3 in which Service 1 exists to join into the specific node;

Step 9, the device 3 joins into the specific node;

Step 10, the device 2 invites the device 4 in which Service 2 exists to join into the specific node;

Step 11, the device 4 joins into the specific node;

Step 12, the device 2 sends a service calling message to Service 1;

Step 13, the device 2 sends a service calling message to Service 2.

FIG. 3A shows a generating procedure of a node including a global node or a specific node. A complete node generating and removing procedure should comprise the steps of device announcement, node creation, node expansion, node cancellation, global node management and device election etc. It should be noted that during dynamic networking, it is not necessary that the global node and the specific node co-exist. Dynamic networking and resource sharing among can be achieved only if the global node or the specific node is created.

In above steps, all the devices existing in the same broadcasting domain belong to a same global node in default. In case of being allowed by its own abilities, Any device can serve as the node control device of the global node only if the ability of the device allow it. However, only one global node control device such as the device 1 can exist in one broadcasting domain at the same time. A lifetime of the global node will be automatically ended when there is no control device in the network.

If the global node has already exists in the broadcasting domain where the device is, the device should join into this global node. When joining into the global node, the device should register its own service information to the control device of the global node. The global node control device manages the services on all devices, and the global node only serves to perform a service indexing function for the management to the respective device service.

Any one of the devices, such as the device 2 in the network, can create the specific node besides the one global node. That device can invite other devices to join into the newly created specific node. Except the control device of the global node, one device can only be active in one node at same time. The node control device which creates a specific node maintains the lifetime of the specific node.

The control device of the node controls the lifetime of the node, e.g. device 1 controls the lifetime of the global node, and device 2 controls the lifetime of the specific node. When the control device decides to cancel a previously created node, it will send node quitting message to respective devices in the node. When quitting a node ever participated, the device will cancel all the service information of the device from the control device of the global node.

After the creation of a new node including the global node and the specific node, the node control device of the node, i.e. device 1 and device 2 in the drawing, will be responsible for announcing the message of existence of the node to the network, and the node announcement message is sent with multicasting. The node announcement message at least includes a network addressing identification of the node control device, the type of the node, an identifier of the node, and other relative property information. Other devices, as soon as they monitor the node announcement message, can send a joining request to the node control device of the node such as device 1 and device 2. Or, the node control device configures other devices on the network so that those devices must register service information provided thereon to the node control device so as to join into the node.

All devices in the network perform device information announcement with multicasting. They periodically multicast device announcement messages to the network, and indicate network addressing identifications of the devices, devices descriptions, and service information on the devices contained in the messages so that other devices can obtain information relative to the devices.

The node control device periodically announces message to the network about its existence in the network. The node announcement message at least includes a network addressing identification of the node control device, the type of the node, an identifier of the node and other relative property information. The node announcement message is transmitted with multicasting.

Any device in the network can look up the nodes existing in the network in an active or passive mode. The active mode refers to that the device sends a node looking up message to the network with multicasting, and the node control device satisfying the looking up criteria sends the node announcement message to the device from which sent a looking up message with unicasting. The passive mode refers to that the device monitors a designated multicasting address to obtain the message of the node in the same broadcasting domain or different broadcasting domain.

When a device finds that there is a node message in the network, the device can initiate a node joining request to the control device of the node, and the node control device determines whether the device is permitted to join into the node, i.e. whether a node expansion is performed.

The node control device may also obtain device messages currently appearing on the network by monitoring the device announcement message on the network. Also, the node control device may initiate a node joining invitation to the device and the device determines whether it will join into the node or not.

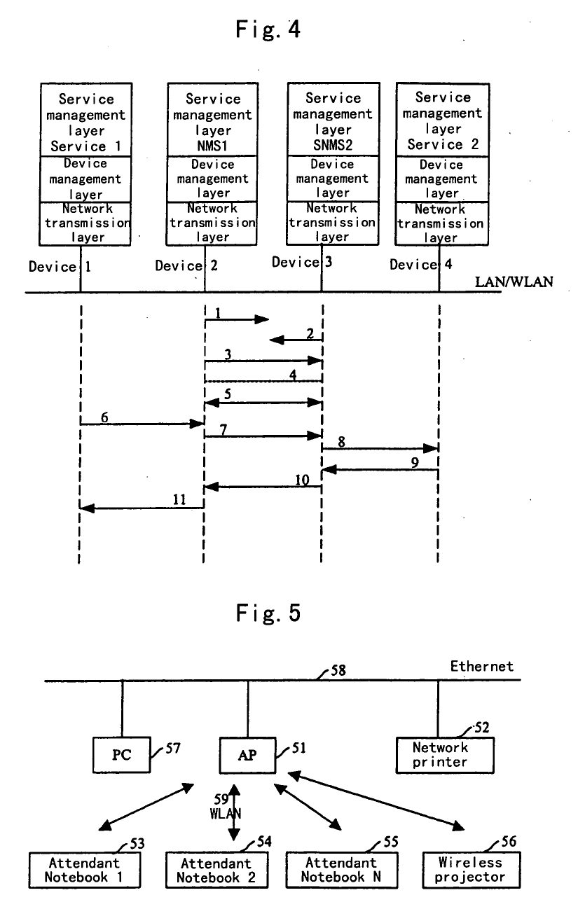

Referring to FIG. 4, the communication mechanism among devices is shown. A device 1, a device 2, a device 3 and a device 4 are connected to a LAN/WLAN, wherein NMS 1 (Node Management Service) is a service entity on device 2 for performing the management to a global or specific node 1, NMS 2 is a service entity on the device 3 for performing the management to a global or specific node 2, and Service 1 is a service on the device 1 within the node 1, Service 2 is a service on the device 4 within the node 2. NMS 1 and NMS 2 perform communication between nodes as follows:

Step 1, device 2 sends a node announcement message of node 1 to the network;

Step 2, device 3 sends a node announcement message of node 2 to the network;

Step 3, node 1 initiates a resource sharing request to node 2;

Step 4, node 2 accepts the resource sharing request from node 1, and a resource sharing relationship between nodes is established between node 1 and node 2;

Step 5, node 1 and node 2 exchange node resources information;

Step 6, Service 1 on device 1 within node 1 initiates a calling request to Service 2 on device 4 within node 2;

Step 7, the control device of node 1 forwards the calling request to the control device of node 2;

Step 8, the control device of node 2 forwards the calling request to device 4;

Step 9, Service 2 of device 4 sends back a calling response to the control device of node 2;

Step 10, the control device of node 2 forwards the calling response to the control device of node 1;

Step 11, the control device of node 1 forwards the calling response to device 1.

In above steps, the communication between two different global or specific nodes is executed by respective node control devices. The control device of the two nodes can find each other by the node announcement message of the opposite party. The control device of one node (called a source node control device) can initiate a resource sharing request to the control device of another node (called a destination node control device). The destination node control device accepts or rejects the node resource sharing request according to its own security strategy. After the two nodes establish the resource sharing relationship, they can exchange node resources information. The devices within the two nodes can perform resource sharing through respective node control devices. The calling response therein includes joint control information between the service calling information and service.

Referring to FIG. 5, it shows that the method according to the present invention is applied to a meeting room so as to form a network structure in an intelligent meeting room. In FIG. 5, referential numeral 51 denotes an AP device for providing wireless access, 52 denotes a network printer, 57 denotes a PC (personal computer). AP device 51, network printer 52 and PC 57 are connected over Ethernet network 58. An attendant notebook 1 (53), an attendant notebook 2 (54), . . . , an attendant notebook N (55), a wireless projector 56 and PDAs, and mobile phones (not shown) are used as mobile devices and connected with the AP device 51 over the WLAN 59.

In the environment as shown in the figure, AP device 51 for providing wireless access, network printer 52 and PC 57, wireless projector 56 are stationary devices in the meeting room. In terms of the functionalities and performances of AP device 51, network printer 52 and wireless projector 56, they can not be used as a global node control device. After a plurality of (e.g. N, where N is a positive integer) attendant notebooks come into the meeting room, the administrator of the meeting room designates one of PC device 57 and the N attendant notebooks as the global node control device.

Network printer 52 and wireless projector 56 can register their own services to the global node control device by monitoring the global node announcement message.

After forming the global node, all the attendant notebooks need not install the printer driving program in advance and need not directly connect with the wireless projector, but can perform an ordered control to network printer 52 and wireless projector 56 under the control of the global node control device. Each of the attendant notebooks can use wireless projector 56 and/or network printer 52 by creating a specific node without conflicting.

With the increase of the life quality, the number of the devices such as information devices, communication devices, entertainment devices, home appliances, automatic devices, security (monitoring) devices in a home increases. Meanwhile, because of the wide use of personal computers and Internet in home, the development of telecommunication technologies and the advance of intelligent devices, the home network is intended to be paid more and more attention to, and the demands to a simple, flexible and reliable home network are increasing. Currently, there are a lot of related technical terms, such as Smart Home, Electronic Home, e-Home, Digital Family, Network Home, and Intelligent Home. The contents and concepts covered by these technical terms are basically similar, and are all originating from the home network. Therefore, the technology of home network is a key technology to digitalize the home devices. With the method according to the present invention, all the electrical equipments in a home can be dynamically connected as a whole, and perform devices interconnection and information delivery at any time.

Specifically, home network comprises following meanings:

1. Information devices, communication devices, entertainment devices, home appliances, automatic devices, security (monitoring) devices in a home can be interconnected with each other and be dynamically networked to realize resource sharing and form a home intelligent network system;

2. The home network connects with a society network or Internet network through a gateway so as to realize information exchange with the environment outside of the home;

3. The home devices and the network connected thereto should satisfy the basic requirements of security, convenience, comfortable, healthy and environmental protection, so as to make persons enjoy and happy;

4. The concept of human being centered should be embodied, it should be easily to use, secure, convenient and unexpensive so as to meet the requirements of family life.

The requirements to home networks are completely different from those to commercial networks. A topological structure of network architecture for Digital Family mainly includes two hierarchies, one is a backbone network and the other is a control subnet. The backbone network is used to realize the interconnection among information devices, communication devices and entertainment devices etc. (generally refer to the devices with good computing capabilities and memory capabilities). The control subnet connects the home appliances such as a refrigerator, a washing machine, an air conditioner to the backbone network through a control gateway. For realizing interconnection with some wireless mobile devices and making the users enjoy an arbitrary information access, the home backbone network further supports wireless connecting and access mode, and thus with respect to networking mode, the home backbone network should contain two parts, i.e. wired part and wireless part. Furthermore, the external Internet can connect to the home backbone network through a portal gateway so as to perform a wideband access.

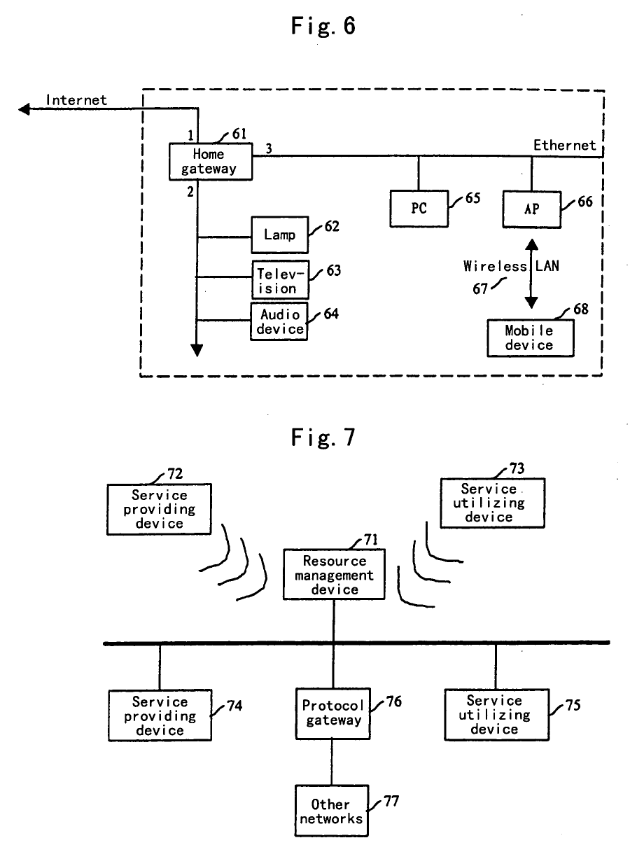

Referring to FIG. 6, this figure shows an embodiment of the structure of the home network, which is implemented by Ethernet, established in accordance with the networking method of the present invention. The backbone network has two transmission modes, i.e., wired and wireless. The requirements to home backbone network are mainly high rates transmission, high quality of service, dynamic networking and effective resource sharing. Various and complex appliances in home can be made to interconnect and operate jointly and realize dynamic networking and resource sharing among devices effectively.

In FIG. 6, referential numeral 61 denotes a home gateway including a portal gateway and a control gateway, 62 denotes a lamp, 63 denotes a television set, 64 denotes a audio device, 65 denotes a PC, and 66 denotes an AP device for providing a wireless access, which connect to mobile device 68 including PDAs, notebook computers etc. through WLAN 67. The home gateway 61 has a performance of low power consumption without power off. Further, the home gateway 61 has various network interfaces, for example, interface 1 is an external Internet interface for connecting to Internet, interface 2 is an RS232 interface for connecting to lamp 52, television 53 and audio device 54 etc., and interface 3 is an Ethernet interface for connecting to the PC 65, AP machine 66 and so on. The home gateway 61 can be designated manually as the global node control device.

The AP device 66 within the backbone network is a device for providing wireless access, and the mobile device 68 connected to the backbone network through the WLAN 67. The node control device (also referred to as a resource management device) on the backbone network should be an information device such as a PC that various services can be run thereon. Here, the home gateway 61 has a function of the protocol gateway through which the backbone network can interact with the devices such as television, audio device and lamp within Internet 1 and in control subnet 2. In addition, the home gateway 61 can function as a resource management device to which all the devices on the backbone network register. The home gateway 61 is responsible for indexing all the devices and their services on the backbone network. The network devices such as the PC device 65, the mobile device 68 in the home can find the global node which control device is the home gateway 61 by monitoring the global node message after entering into the Ethernet.

Conventional home appliances such as the lamp 62, the television 63 and the audio device 64 can connect to the home gateway 61 through various home network standard interfaces such as RS232 interface based on standardized home network protocols such as CEBus. In the home gateway 61, an issuance and control to CEBus network service are performed by running a CEBus network proxy service entity.

After joining into the global node, the PC 65 or the mobile device 68 can find respective devices in the home network by using node service and retrieve service provided by the global node control device, i.e. the home gateway 61. Furthermore, it can create a specific node under the management of the global node control device to thereby control respective devices. For example, the PC 65 or the PDA belonging to mobile device 68 can be used to control the television 63, audio device 64 and so on.

Similarly, with the node generation mechanism of the present invention, those devices outside the home can access into the home network by the network access service provided by Internet and the home gateway 61, and thereby join into the node in the home network so as to perform a remote control to the home electrical appliances.

Next, a networking method for realizing a home backbone network (a global node) by using the method of the present invention will be further described by combination with the embodiments. The home backbone network constitutes an information/multimedia network of the family, and achieves a dynamic networking interconnection among information devices, communication devices, entertainment devices and so on. The data transmitted in the home backbone network mainly includes information such as text, picture, audio and video etc.

In the following, the related members, including information devices, communication devices, entertainment devices etc., of the home backbone network can interact with Internet and some home appliances such as refrigerator, washing machine, television, audio device and so on by protocol gateway. Therefore, these devices are carriers for providing services and acquiring services. Each of the devices supporting the backbone protocol has a unique identifier which is called a device identifier. The involved protocol gateway provides a service for converting different protocols. The resource management device, i.e. the global node control device, refers to a device which can provide a function of registration and service indexing to the devices in the network. The service providing device refers to a device for providing services to other devices in the network. Said service refers to a function entity running on the devices and consistent with the standard interface defined by the backbone network protocol, and each service has an identification number called service identification which can be a 32-digit unsigned integer type number. The service identification is assigned by the device providing such service. Said service providing device refers to a device for providing services to other devices in the network. Said service utilizing device refers to a device utilizing the services provided by other devices in the network. Said unicasting refers to that a sending device sends information to a designated receiving device. Said multicasting refers to that a sending device sends information to a set of designated receiving devices. In actual home network, a device can serve as a service providing device to provide services to other devices, and at the same time as a service utilizing device to utilize services provided by other devices.

Referring to FIG. 7, a topological structure of a home backbone network established in a Master/Slave connecting mode is shown. In the network, there exists a centralized control device, i.e. a resource management device 71. Other devices in the network include a service providing device 72 and/or a service utilizing device 73 accessing into the backbone network in a wireless mode, and a service providing device 74 and/or a service utilizing device 75 accessing into the backbone network in a wired mode. The service providing devices 72, 74 and/or the service utilizing device 73, 75 will register to the resource management device 71 and the registration shall be successful when they join into the home backbone network. The activities of other devices joined into the home backbone network are controlled by the centralized control device, that is, the service function is indexed from the resource management device. A protocol gateway 76 performs communication between the home backbone network and other network 77 such as an external Internet.

A home backbone network device can be not only a service providing device, but also a service utilizing device. The resource management device can serve as a service providing device or a service utilizing device in addition to take the task of resource management.

Generally, the home backbone network is implemented by a wired Ethernet network, or by a wireless Ethernet network, or by a combination of a wired and wireless Ethernet network, whose characteristics are wide frequency band and high rate.

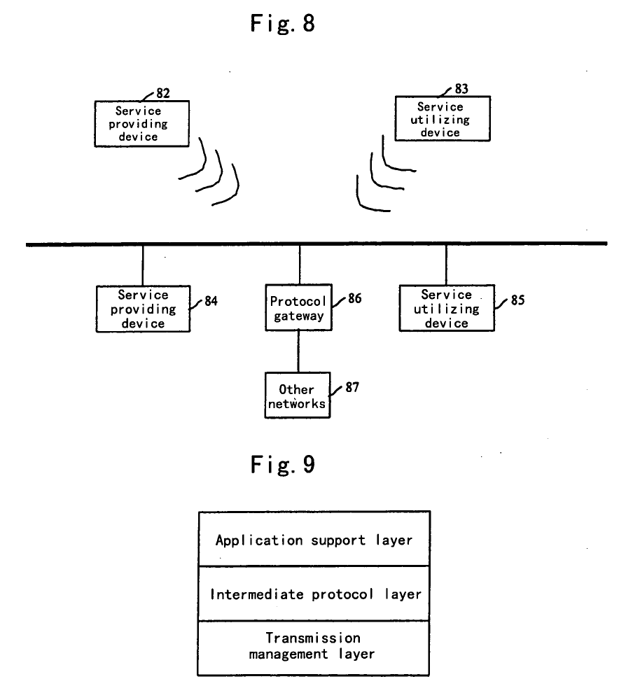

Now referring to FIG. 8, this figure shows a topological structure of a home backbone network established in a peer-to-peer connecting mode. The home backbone network includes a service providing device 82 and/or a service utilizing device 83 accessing into the backbone network with a wireless mode, and a service providing device 84 and/or a service utilizing device 85 accessing into the backbone network with a wired mode. A protocol gateway 86 performs communication between the home backbone network and other network 87 such as an external Internet.

The difference from the Master/Slave mode as shown in FIG. 7 is in that there is no centralized control device, i.e., resource management device, in the network. In a peer-to-peer mode, the relationships among the service providing device, the service utilizing device, and the protocol gateway are equivalent. In a peer-to-peer network, one device can be both the service providing device and the service utilizing device.

The procedure to establish the peer-to-peer connection is realized by sending a peer-to-peer connection establishing request from a source device to a destination device and sending back a peer-to-peer connection establishing response from the destination device to the source device. The source device and the destination device can be either the service utilizing device or the service providing device which are interchangeable.

The method for establishing the home backbone network according to the present invention can establish a basic frame of the home backbone network, and on the basis of the basic frame, the dynamic networking among respective devices in the home network can be flexibly and conveniently achieved and thus the resource sharing can be realized.

Next, a method for realizing dynamic networking and resource sharing among devices in a home backbone network by using the method according to the present invention will be described by referring to embodiments and drawings. Supporting dynamic networking in a home backbone network means that the devices in the home backbone network can dynamically select relevant devices from the network to form a home network to realize a function that can not be achieved by a single device, or to improve performance of an original function of any a single device without performing configuration of network parameters in advance manually. Resource sharing means that the devices in the home backbone network can announce the resource provided by themselves and at the same time can conveniently retrieve and utilize resources provided by other devices; as well as the function of a single device can be extended through direct communication and resource sharing between any two devices.

The existing TCP/IP protocol has provided a basic communicating and addressing method for the network devices. In the home backbone network, based on the particularly requirements of the home networking, in order to realize dynamic networking and resource sharing in the extension of the home more efficiently, the home backbone network protocol is designed based on TCP/IP protocol in the present invention. In the home backbone network, the dynamic networking and resource sharing among devices in the home backbone network includes procedures of a device discovery, a service discovery, a device registration, a device connection, a service registration, a service access, a service invocation and so on which are processed according to corresponding sub-protocols.

Device manufacturers and service providers provide information about the devices and the services. Those devices information and service information thereof are encapsulated according to the protocol for the backbone network. The encapsulated information is issued in the network by using the device discovery procedure and the service discovery procedure. A home backbone network is dynamically established among a plurality of devices through the procedures of device registration, service registration and device connection. In the home backbone network, there may be one home resource management device functioning as centralized index and service access authorization (Master/Client connecting mode), and there may be no home resource management device (peer-to-peer connecting mode). In the latter case, all devices on the network connect with one another in the form of complete peer-to-peer. The services on the devices are shared as resources by using service calling procedure.

Referring to FIG. 9, a structure of a protocol stack for a backbone network used by the method according to the invention is shown. Logically, the protocol stack is divided into three layers including an application support layer, an intermediate protocol layer and a transmission management layer from the top to the bottom.

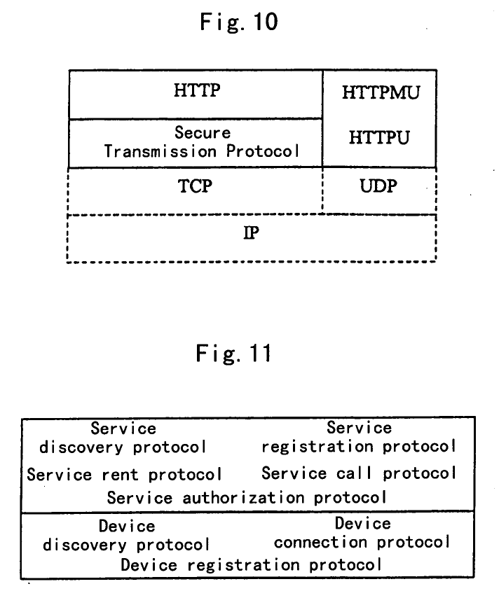

The transmission management layer is a basis for the intermediate protocol layer to exchange data, and used for data exchanges among devices and services. All data exchanges are based on TCP/IP protocol. The transmission management layer is based on TCP/IP and HTTP protocols and its structure are shown in FIG. 10, and includes HTTP (HTTP, HTTPMU, HTTPU) protocol, secure transmission protocol, TCP (UDP) and IP from the top to the bottom. When transmission is based on TCP, the secure transmission protocol is responsible for the security of a transmission channel.

The intermediate protocol layer is used to realize the interconnection and resource sharing among the network devices. The intermediate protocol layer consists of several sub-protocols including a device discovery protocol, a device registration protocol, a device connection protocol, a service registration protocol, a service discovery protocol, a service rent protocol, a service authorization protocol, a service calling protocol, a device authentication and secure transmission protocol. The logical relationships among the respective sub-protocols of the intermediate protocol layer are shown in FIG. 11. Those sub-protocols located in a upper layer are the service discovery protocol, the service registration protocol, the service rent protocol, the service calling protocol, and the service authorization protocol in the order from the top to the bottom. Those sub-protocols located in a lower layer are the device discovery protocol, the device connection protocol and the device registration protocol in the order from the top to the bottom.

The device discovery protocol, the device registration protocol and the device connection protocol are the bases for the implementation of other sub-protocols in the intermediate protocol layer. On the basis of their running, the services can be operated by using the service registration protocol, service discovery protocol, service rent protocol, service invocation protocol and service authorization protocol, etc.

The application support layer provides a software API access interface for upper applications. On the basis that the intermediate protocol layer provides the core protocols of interconnections and resource sharing, a application support layer protocol provides a corresponding software interface for a certain application development. Also, the interoperation among the same type devices from different manufacturers can be ensured by designing a uniform application support layer protocol.

The devices in the home backbone network are connected through a Local Area Network (LAN) or a Wireless Local Area Network (WLAN). The primary step for realizing dynamic networking and resource sharing is device discovery. Each of devices compatible with the method according to invention periodically announces relevant information of the device to the network in a form of multicasting. The announcement messages include device description information, the network addressing identification of the device, the service information provided by the devices. The device can obtain the message of existence of other devices by monitoring device announcement messages of other devices, and can also send request information to look up devices with multicasting which contains looking up criteria. If those looking up criteria in the request information are satisfied, the device receiving the looking up request information will return its own device announcement information in a form of unicasting.

When there is a home resource management device generally designated by users, a home backbone network consists of one home resource management device and those devices registering thereto. The generation procedure of such a home backbone network is as follows.

If a resource management device is designated in the service utilizing devices or in the service providing devices, and when the resource management device exists in the network, the service utilizing devices or the service providing devices will initiate the registration procedure to the resource management device;

If a resource management device is not designated in the service utilizing devices or in the service providing devices, and when a resource management device exists in the network, the service utilizing devices or the service providing devices will initiate the registration procedure to the resource management device. If there are two or more resource management devices in the network at the same time, then according to a sequence of the program execution, the resource management device which first initiates the device registration procedure to the devices will be used as the resource management device for constituting the home network.

The service utilizing device or the service providing device can only register to one resource management device at a time.

After the service providing device successfully registers to the resource management device, it will also register its own services to the resource management device. The resource management device will maintain all device information and relevant service information registered thereto. At any time, the service utilizing device or the service providing device can quit the home network by sending the device cancellation request to the resource management device. Meanwhile, the resource management device will delete registration information of this device and registered service information thereon.

When there is no home resource management device, all home devices perform communication, dynamic networking and resource sharing in a peer-to-peer mode, and thus construct a home backbone network. The generating procedure of such a home backbone network is as follows:

A home device can obtain information of other devices by monitoring the multicast announcement messages of other devices, so as to perform a corresponding request to the services of other devices. The service utilizing device or the service providing device may drop off the home network unexpectedly, for example because of powered off. And also, the service utilizing device can initiate an announcement request to release the connection to the service providing device, and then quit the home network.

The home network finishing the dynamic networking shares the resources as follows.

For those home networks with the home resource management devices, a service utilizing device joining into one home network can obtain service information of other devices within the home network by initiating the service looking up request to the resource management device of the home network, can obtain the right to utilize a service by initiating the service renting request to the service providing device providing the corresponding service, and can utilize the service by initiating the service calling request to the service provided by the corresponding service providing device.

For those home networks without the home resource management devices, after a service utilizing device has established a peer-to-peer connection with a service providing device, the service utilizing device can obtain service information of the service providing device by initiating the service looking up request to the service providing device, can obtain the right to utilize a service by initiating the service renting request to the service providing device, and can utilize the service provided by the service providing device by initiating the service calling request to the service providing device.

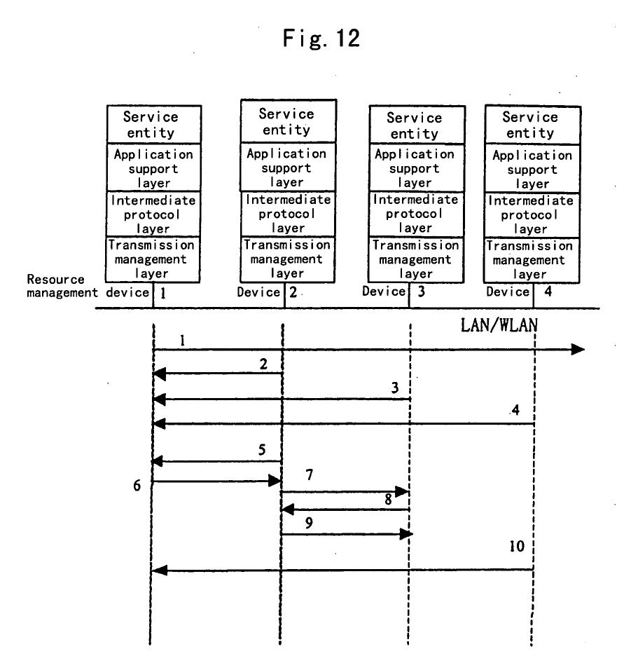

Referring to FIG. 12, a complete procedure of dynamic networking for a home backbone network is shown. The procedure includes a device announcement, a device registration, a service registration, a service look up, a service rent, a service calling and a device cancellation.

In FIG. 12, a device 1, a device 2, a device 3 and a device 4 are connected to a LAN or a WLAN. It is assumed that the device 1 is the resource management device of the home network, the device 2 is the service utilizing device, the device 3 and the device 4 are the service providing devices, and each of the devices 1, 2, 3, 4 has respective service entities of its own.

The meanings of the steps in FIG. 12 are as follows:

Step 1, the resource management device 1 announces a device announcement message outward;

Steps 2, 3 and 4, device 2, device 3 and device 4 as the service utilizing devices or service providing devices, in accordance with the announcement message of the resource management device 1, perform the device registration. The devices 2, 3 and 4 which have subjected to their device registration further register their service entities which have been locally registered to the resource management device 1;

Step 5, the service on the device 2 enquires (looks up) other service information in the network to the resource management device 1;

Step 6, the resource management device 1 returns relevant service information to the service on the device 2 which initiates the looking up;

Step 7, the service on the device 2 initiates the renting request information to the service on the device 3;

Step 8, the service on the device 3 returns the renting response information to the service on the device 2 which initiates the renting request;

Step 9, the service on the device 2 sends the calling information to the service on the device 3 which is successfully rented; and

Step 10, the device 4 sends the device cancellation to the resource management device 1 and then quits the network.

To implement the method according to the present invention, a security mechanism interacting among the devices in the home network must be established, which includes the establishment of the security mechanism when there is the home resource management device and the establishment of the security mechanism when there is no home resource management device.

When there is the home network resource management device, if a device intends to join into the home network, it must register to the resource management device. During the registration, the resource management device initiates authentication to the device, if the authentication is passed, then the registration of the device is successful. A dedicated key configuration management program charges for the authentication key, and the program can be provided on the resource management device or on any other device with human-computer interaction capability. The key configuration management program is in charge of not only the configuration of the authentication key between the device and the resource management device, but also the configuration of the connection authentication key between devices. The connection security key between devices is based on a private key, that is to say, the connection authentication key between devices is negotiated between the two specific devices. Another use of the connection authentication key between the devices is to establish the transmission key between the two devices on the basis of the key so as to perform secure transmission.

When there is no home network resource management device, if a device intends to join into the home network, the security mechanism is similar to that when the home resource management device exists, except that the authentication procedure between the device and the resource management device is replaced with the connection authentication procedure between devices. The connection authentication key between devices is issued by the key configuration management program and held locally to the device.

A dedicated key configuration management program charges for key configuration. The configuration is performed manually by a user. The key configuration management program needs the support of the human-computer interacting interface. If the device can not afford a human-computer interacting interface, then the configuration program can not be executed. At that time, the device can only remotely configure its device connection authentication key with aid of other devices which are able to execute the key configuration management program. The key configuration management program can be configured on any device having human-computer interacting capability. For example, when there is the resource management device in the home network, the key configuration management program can be configured on the resource management device; and when there is no resource management device in the home network, the key configuration management program can be configured on a device having human-computer interacting capability.

The configuring method of the device authentication key is that, the key configuration management program sends out the authentication configuration information in a form of multicasting. If the device, after receiving the message, judges that it is in a state that no key is set, the device then sends the key configuration request in response to the message. The configuration management program sets a corresponding key in response to this request. One example is that a default key is set when a device is produced in manufacturer, and when a key configuration management program performs a key configuration, it is needed to know the default key.

The method according to the present invention supports dynamic networking and resource sharing among devices over a home backbone network in the extension of the home network, so that the interoperability and easy usage among the home devices are improved. Any device in the home network which is compatible with a protocol for the backbone network can announce its own resource information to the network, and find resource information provided by other devices. Thus, resources are shared among devices in accordance with the protocol for the backbone network.

1. A method for dynamically networking and resource sharing among devices, comprising the steps of:
A1. installing a set of dynamic networking and resource sharing module on each of devices desired to realize dynamic networking and resource sharing, said module set including a network transmission layer module for transmitting and receiving data; a device management layer module for controlling and managing the connection among the devices; a service management layer module for performing a service management for the device itself and a node, these devices periodically sending device announcement messages to the network with multicasting;
B1. a device serves as a node control device and announces a message of the existence of the device with multicasting so as to create a node;
C1. a device finds the node by monitoring a node announcement message, and a device which request to join into the node registers its service information which can be provided to the node control device of the node; or the node control device configures other devices on the network so as to make said device has to register its service information which can be provided to the node control device and joins into the node;
D1. the device which has joined into the node finds a device providing service by indexing the node control device, and obtains a desired service from said device by sending a service calling message.

2. The method for dynamically networking and resource sharing among devices according to claim 1, wherein said nodes comprise a global node and a specific node, service entities on all devices belong to the same global node in default, and a service entity on any one of the devices can create a specific node other than the global node.

3. The method for dynamically networking and resource sharing among devices according to claim 1, wherein in said step A1, the devices periodically send the device announcement messages to the network with multicasting, said device announcement message at least includes a network addressing identification of the device, a device description information, and service information carried by the device.

4. The method for dynamically networking and resource sharing among devices according to claim 1, wherein in said step B1, a device serving as the node control device may be designated by a user or dynamically generated.

5. The method for dynamically networking and resource sharing among devices according to claim 1, wherein in said step B1, the announcement message of the node control device at least includes a network addressing identification of the node control device, the type of the node, a node identifier of the node and other relevant property information.

6. The method for dynamically networking and resource sharing among devices according to claim 1, wherein in said step B1, a lifetime of the node in the network is same as the duration of the creating and the removing of the node; when the node control device cancels a created node, it sends a node quitting notice to all the devices in the node.

7. The method for dynamically networking and resource sharing among devices according to claim 1, wherein said Step C1 further comprises a step of a device which quits the node cancels the service information which can be provided by the device from the node control device of the node.

8. The method for dynamically networking and resource sharing among devices according to claim 1, wherein the indexing in said Step D1 is performed by looking up the nodes existing in the network in an active mode by the device, said active mode refers to that the device sends a node looking up message to the network with multicasting, and the node control device satisfying the looking up criteria sends the node announcement message to the device which performs the looking up with unicasting.

9. A method for dynamically networking and resource sharing among devices according to claim 1, wherein the indexing in said Step D1 is performed by looking up the nodes existing in the network in a passive mode by the device, said passive mode refers to that the device monitors a designated multicasting address to obtain the message of the node in the same broadcasting domain or different broadcasting domain.

10. A method for dynamically networking and resource sharing among devices according to claim 1, further comprises a communicating method among nodes, including the steps of:
E1. a source node control device and a destination node control device respectively send respective node announcement messages of their own nodes to the network;
F1. the source node control device and the destination node control device establish resource sharing between the two nodes, and exchange resource information by using procedures of initiating request and receiving request respectively;
G1. the device within the source node sends a request, which is transferred by the destination node control device, to its node control device to call for the resource of a device within the destination node;
H1. the device within the destination node sends back a resource calling response, which is transferred by the source node control device, to the device within the source node.

11. A networking method for a home backbone network, comprising the steps of
A2. providing at least one service providing device for providing services to other devices in the home network;
B2. providing at least one service utilizing device for utilizing the services provided by other devices in the home network;
C2. providing at least one protocol gateway for connecting the home backbone network with an external network;
D2. connecting the service providing device, the service utilizing device and the protocol gateway by using a broadband and high rate home backbone network protocol to form the home backbone network.

12. The networking method for a home backbone network according to claim 11, wherein the service providing device and the service utilizing device in said Steps A2 and B2 may exist on the same physical device.

13. The networking method for a home backbone network according to claim 11, wherein said home backbone network adopts a wired transmission mode or a wireless transmission mode or both of them.

14. The networking method for a home backbone network according to claim 11, wherein said service providing device or said service utilizing device or said protocol gateway is designated as a resource management device of the home backbone network so as to constitute a backbone network topological structure of Master/Slave connection mode between the resource management device and other devices, and the resource management device performs centralized control to the other devices.

15. The networking method for a home backbone network according to claim 14, wherein said centralized control includes that the service providing device and/or the service utilizing device, after successfully registering to the resource management device, join into the home backbone network, as well as the service utilizing device which has joined into the home backbone network indexes services from the resource management device.

16. The networking method for a home backbone network according to claim 11, wherein a peer-to-peer connecting backbone network topological structure consists of said service providing device, said service utilizing device and said protocol gateway connected in a peer-to-peer connecting mode.

17. The networking method for a home backbone network according to claim 16, wherein said peer-to-peer connection is performed in such a manner that a source device requesting connection sends a peer-to-peer connection creation request to a destination device and the destination device send a peer-to-peer connection creation response to the source device.

18. The networking method for a home backbone network according to claim 17, wherein said destination device and source device can be the service providing device or the service utilizing device for each other.

19. The networking method for a home backbone network according to claim 11, wherein said service providing device and service utilizing device are interchangeable, and a home backbone network can be both a service providing device and a service utilizing device.

20. The networking method for a home backbone network according to claim 11, wherein the home backbone network is implemented by a wired Ethernet network, or a wireless Ethernet network, or by the combination of a wired and wireless Ethernet network.

21. A method for dynamically networking and resource sharing among devices in a home backbone network, comprising the steps of:
A3. connecting a home network device to a local area network (LAN) or a wireless local area network (WLAN);
B3. multicasting information of said device by issuing an announcement message of said device;
C3. obtaining an message of existence of other devices by monitoring or looking up the announcement message;
D4. a service utilizing device and a service providing device, together with one resource management device, constituting one home network by registering to said resource management device; or more than one service utilizing devices and service providing devices constituting one home network by using peer-to-peer connecting mode;
E3. the service utilizing device which has joined into the home backbone network obtains service information of the service providing device within the home backbone network by sending a service looking up request to the resource management device, and the service utilizing device obtains a right to use a service, and uses the service provided by the service providing device by sending a service renting request or a service calling request; or the service utilizing device obtains service information of a service providing device and a right to use a service, and uses the service provided by the service providing device by sending a service looking up request, a service renting request and a service calling request to the service providing device which has established a peer-to-peer connection with the service utilizing device.

22. The method for dynamically networking and resource sharing among devices in a home backbone network according to claim 21, wherein in said Step A3, said home backbone network includes information devices, communication devices and entertainment devices, information of the device and services thereof is encapsulated and issued in accordance with a description specification of a device and its services of a backbone network protocol.

23. The method for dynamically networking and resource sharing among devices in a home backbone network according to claim 22, wherein the backbone network protocol stack includes a transmission management layer for data interaction among devices and services, an intermediate protocol layer for realizing an interconnection and resource sharing among the devices in the home network, and application support layer for providing an API access interface for an upper layer application program.

24. The method for dynamically networking and resource sharing among devices in a home backbone network according to claim 21, wherein in said step B3, the device periodically announces its own information with multicasting, and the issued announcement message at least includes a network addressing identification of the device, a device description information, and service information carried by the device.

25. The method for dynamically networking and resource sharing among devices in a home backbone network according to claim 21, wherein in said step C3, said monitoring includes that the device obtains the messages of existence of other devices by monitoring the announcement messages of other devices; and said looking up includes that the device sends a message to look up other devices with multicasting, and a device which receives the looking up message multicast returns its own device announcement message with unicasting when the conditions of the device itself is consistent with the looking up conditions contained in the looking up message.

26. The method for dynamically networking and resource sharing among devices in a home backbone network according to claim 21, wherein in said step D3, when the resource management device is designated in the service utilizing or service providing device, the service utilizing device or service providing device initiates a registering procedure to the designated resource management device existing in the network; when the resource management device is not designated in the service utilizing or service providing device, the service utilizing device or service providing device initiates a registering procedure to an arbitrary resource management device existing in the network.

27. The method for dynamically networking and resource sharing among devices in a home backbone network according to claim 21, wherein in said step D3, said service utilizing device or service providing device only registers to one resource management device at the same time.

28. The method to realize dynamic networking and resource sharing among devices in a home backbone network according to claim 21, wherein said step D3 further comprises steps of the service providing device which has successfully registered to the resource management device registers its own service to the resource management device, and the resource management device maintains all devices and their service information registered thereto.

29. The method for dynamically networking and resource sharing among devices in a home backbone network according to claim 21, wherein in said step D3, i.e. the step of more than one devices constitute one home backbone network by using peer-to-peer connecting mode, further comprises the steps of a device obtains the messages of existence of other devices by monitoring multicast announcement messages of other devices, and a device initiates a peer-to-peer connection establishing request to other devices so as to request services on other devices.

30. The method for dynamically networking and resource sharing among devices in a home backbone network according to claim 21, wherein said step D3 further comprises a establishing procedure of a security mechanism, including the steps of:
D31. the resource management device sends authentication information to the devices joined into the home network, wherein a key configuration management program is responsible to a authentication key thereof and if the authentication is passed, then the registration is successful;
D32. performing a connection authentication between two peer-to-peer connected devices, a connection authentication key being issued by the key configuration management program and being maintained locally by the two peer-to-peer connected devices.

31. The method for dynamically networking and resource sharing among devices in a home backbone network according to claim 30, wherein in said steps, a private key is negotiated between the devices in the home backbone network, a key configuration management program charges for a configuration of a connection authentication key, and a transmission key between the two devices is established on the basis of said connection authentication key so as to perform a secure transmission.

32. The method for dynamically networking and resource sharing among devices in a home backbone network according to claim 30, wherein the step of configuring the key by said key configuration management program comprises that the key configuration management program sends out an authentication configuration message in a form of multicasting; if the device, after receiving the message, judges that it is in a state that no key is set, the device then sends a key configuration request in response to the message; and the configuration management program sets a corresponding key in response to the configuration request.

33. The method for dynamically networking and resource sharing among devices in a home backbone network according to claim 30, wherein said key configuration management program is provided on the resource management device or a device having human-computer interacting capability in the home backbone network.

34. The method for dynamically networking and resource sharing among devices in a home backbone network according to claim 21, wherein the service utilizing device or the service providing device quits the home network by sending a device cancellation request to the resource management device, the resource management device deletes registration information of the device and registered service information thereon; or the service utilizing device initiates an announcement request to release the connection to the service providing device, and then quits the home network.
